(19) United States
(12) Patent Application Publication
(10) Pub. No.: US 2018/0339353 A1
(43) Pub. Date: Nov. 29, 2018

(54) METHOD FOR CREATING OR MACHINING GEARS AND GEAR-CUTTING MACHINE DESIGNED THEREFOR

(71) Applicant: GLEASON-PFAUTER MASCHINENFABRIK GMBH, Ludwigsburg (DE)

(72) Inventors: Kurt KLEINBACH, Beilstein (DE); Johannes BROGNI, Dotzigen (CH)

(21) Appl. No.: 15/777,743

(22) PCT Filed: Dec. 7, 2016
(86) PCT No.: PCT/EP2016/002061

§ 371 Date: May 21, 2018

(30) Foreign Application Priority Data
Dec. 7, 2015 (DE) 10 2015 015 810.4

(51) Int. Cl. B23F 17/00; B23F 23/06; B23F 23/12; B23Q 39/02; B23F 19/10

(52) U.S. Cl. CPC B23F 17/006; B23F 23/06; B23F 19/104; B23F 23/1293; B23Q 39/028; B23F 23/1206

(57) ABSTRACT

The invention relates to a method for creating or machining gears on workpieces (W1, W2), in which a rolling first machining engagement between a machining tool (WF; WS) that is driven about its rotation axis (B) and a first workpiece that is rotatable about the rotation axis (C1) of a first workpiece-side spindle (11) is realized at a first location on a gear-cutting machine (100; 200) by means of a tool-side spindle drive motor (22), and in which a second machining engagement is realized at a second workpiece, different from the first workpiece, that is rotatable about the rotation axis of a second workpiece-side spindle (12) that is different from the first workpiece-side spindle, wherein the machining tool can execute, relative to the first workpiece-side spindle, a movement, serving as an axial infeed movement in the first machining engagement, along a tool-side machine axis (Z) that has a direction component in the direction of the first workpiece-side spindle axis and in particular extends parallel thereto, wherein, after the first machining engagement, a tool-side positioning movement that takes place along this tool-side machine axis and allows the second machining engagement is carried out, wherein the second machining engagement is a machining engagement that is identical to the first machining engagement in terms of type of machining, is effected using the same tool-side spindle drive motor as in the first machining, and is carried out in the gear-cutting machine at a second point that is different from the first point.

The invention relates to a method for creating or machining gears on workpieces, in which a rolling first machining engagement between a machining tool that is driven about its rotation axis and a first workpiece that is rotatable about the rotation axis of a first workpiece-side spindle is realized at a first location on a gear-cutting machine by means of a tool-side spindle drive motor, and in which a second machining engagement is realized at a second workpiece, different from the first workpiece, that is rotatable about the rotation axis of a second workpiece-side spindle that is different from the first workpiece-side spindle, wherein the machining tool can execute, relative to the first workpiece-side spindle, a movement, serving as an axial infeed movement in the first machining engagement, along a tool-side machine axis (Z) that has a direction component in the direction of the first workpiece-side spindle axis.

Such methods are well known in the gear-cutting field and may be provided in various forms.

For example, the first machining engagement could be provided for rolling grinding, in which a machining tool is provided as a grinding worm; the first workpiece-side spindle may be supported on a rotating holder as the second workpiece-side spindle, and the second machining engagement may be performed by the grinding worm at the position of the first machining engagement, after rotating the rotary holder by 180°. Such a variant of the method and of the machine construction is disclosed, for example, in DE 699 01 004 T2.

Another machine which is also based on the principle of the round table, not for rolling grinding, but for hob cutting, is disclosed in EP 2 029 306 B1. In this case, a rotating drum having a horizontal rotation axis rotates the second workpiece-spindle into the machining position, where a second machining engagement is performed on the second workpiece by the hob, while the first workpiece is in the transfer position.

Machine constructions are also known, in which on juxtaposed hob and deburring stations a workpiece clamped on a first workpiece-side spindle is subject to a hob cutting, while on a second workpiece-side spindle it is subject to a machining engagement as a secondary machining, i.e. the chamfering/deburring. In EP 1 495 824 B1, on the contrary, the hob and a chamfering tool are positioned on the same shaft.

In the machining of shaft-like workpieces which are provided, at two different axial positions, with a respective gear, it is also known to machine only one of these gears by means of a hob, while the other gear is produced by gear shaping, for example because due to the presence of one shoulder on the workpiece the working space is not large enough for performing a hob cut.

In EP 2 456 588 B1 a method is disclosed, in which high stress levels transmitted to a machining head in a machine are avoided in that in the first machining engagement a cutting operation takes place, wherein the first workpiece-side spindle is moved, while the machining head does not perform any radial feed motion, while in a second machining engagement, on a second workpiece-side spindle a gear grinding takes place. Then the radial feed motion by the machining head takes place, while the second workpiece-side spindle is stationary. This possible solution is however not offered by the machine tool disclosed in EP 2 732 895 A1, which is suitable, for example, for hob cutting or rolling grinding, since the one or more workpiece-spindles are radially stationary with respect to the machine bed.

From the above it can be seen that a multitude of construction possibilities are present, in order to produce or machine gears in an efficient way. The object of the invention is thus to provide an efficient gear manufacturing or machining and to implement this in a constructively simple gear machining tool.

This object is achieved by the invention according to a development of the method of the above said type substantially in that after the first machining engagement, a tool-side positioning movement that takes place along this tool-side machine axis and allows the second machining engagement is carried out, wherein the second machining engagement is a machining engagement that is identical to the first machining engagement in terms of type of machining, is effected using the same tool-side spindle drive motor as in the first machining, and is carried out in the gear-cutting machine at a second point that is different from the first point.

The invention is based on the insight that a simplification of the machine construction is allowed by the fact that a motion axis which is usually provided for example in hob or roll cut machines, but which is only provided for the axial feed motion of the machining tool with respect to the workpiece has a feed stroke which is extended, if required, such that by using the same tool-side spindle drive motor, the machining of a second workpiece clamped on another workpiece spindle may take place. Thus, while at the second position the machining of the second workpiece takes place, on the workpiece on the first spindle a secondary machining may already take place, or the same may be replaced by a successive workpiece to be machined. Thus, an efficient gear machining is achieved by using a structure which is relatively simple with respect to the embodiments known in the state of the art.

The second machining engagement occurs with a temporal separation with respect to the first machining engagement. To this end, the spindle drive motor used may drive, fundamentally, for example in the context of an indirect drive transmission, different workpiece spindles. Particularly preferably however the second machining engagement takes place with a machining tool, which rotates around the same rotation axis of the first machining engagement, and the spindle drive may be a CNC-controlled direct drive.

In this context an embodiment may be envisaged, in which two different machining tools are on a common tool spindle, such as a hob, such as a left-hand and a right-hand hob cutter. In a preferred embodiment, the second machining engagement is performed with the same machining tool as the first machining engagement. This again simplifies the tool-side structure of the machine performing the method.

In particular with very slim gears and correspondingly constructed hobs, for example, as machining tools, a dip machining is fundamentally also possible for the machining engagement. In a preferred variant of the method, during the first and/or second machining engagement a tool-side feed motion along the tool-side machine axis takes place.

The functionality of the machine is not particularly limited by the absolute orientation in space of the tool-side machine axis. In a particularly preferred embodiment, it is however preferred that the workpiece-side spindle axes have a predominantly horizontal orientation component, preferably horizontal and in particular extending coaxially. This causes an advantageous component positioning with respect to the flow of chips and a stable structure.

In addition, it is preferably provided that the axial clamping ends of the first and second workpiece spindles face each other. Furthermore, it is preferred that the tool-side machine axis also has a predominantly horizontal directional component, which is preferably parallel to the workpiece-side spindle axes. These designs allow a very compact design of the machine and a comparatively small space requirement of the machine measured in terms of the achievable efficiency.

In a preferred variant of the method, the first and/or the second workpiece-side spindle is/are fixed in space. As a result, no additional drives for a positioning movement of the workpiece spindles are required, the machine is further simplified and receives a high machine rigidity. This variant is preferably considered for the machining of disc-like workpieces.

In an alternative embodiment of this method, it is provided that the first and/or second workpiece-side spindle is movable with a movement component along its axis. CNC-controlled servomotors can be used to implement these movements. This design is particularly suitable for machining shafts in combination with a tailstock.

In this context, it is provided according to a preferred embodiment of the invention that between the two workpiece spindles a tailstock assembly is arranged which is particularly spatially fixed and in particular axially acting on both sides. Such an arrangement is also disclosed by the invention as a separately protected and independent embodiment. The invention thus also relates to a tailstock assembly for use in a gear cutting machine, in particular for a spatially fixed coupling relative to the machine and with two opposite sides with respect to an axial direction, on each of which a tailstock tip is arranged.

In a particularly preferred embodiment, a subsequent secondary machining is performed on the first workpiece, in particular in the form of a chamfering and/or deburring operation in the same holding fixture as in the first machining operation. It is thus advantageously achieved that the first workpiece, after being clamped by the first workpiece spindle, already has chamfered tooth edges, without having to be clamped again later to produce the chamfer. Likewise, such secondary machining can also be performed on the second workpiece on the second workpiece spindle.

For this purpose, it is particularly preferred that the secondary machining unit carrying out the secondary machining is moved after the machining of the first workpiece, in particular parallel to the tool-side machine axis, for secondary machining of the second workpiece. In this design, only one secondary machining unit is required. Thus, in a particularly preferred embodiment of the method, both the machining tool and the secondary machining tool perform reciprocal movements in a push-pull mode.

The chamfering could in principle take the form of a cutting chamfering as well as chamfering by plastic deformation of the tooth edge by methods known to those skilled in the art. Particularly in the latter variant, it is preferred that on the first workpiece, a subsequent machining operation following the first machining takes place at the first location and using the same tool spindle-side drive motor and in particular the same machining tool as in the first machining engagement. In this way, without any additional positioning movement of the first workpiece, the secondary burrs caused by the plastic deformation of the tooth edges during chamfering on the tooth flanks are eliminated. In the same way, it is possible to proceed at the second position for the second workpiece.

The method can be performed with a high cycle rate and efficiency. Thus, the workpieces can be replaced on the first and on the second spindle after completion of their machining by a workpiece change arrangement with new workpieces to be machined. In this case, the replacement of the first workpiece in the above-mentioned variant of secondary burr removal may be placed temporally predominantly within the period, which is determined by the positioning movement of the machining tool along the tool-side machine axis to the second workpiece spindle, its local machining engagement and its return to the first workpiece spindle.

The second machining engagement is of the same type as the first machining engagement. If the type of machining of the first machining engagement is hobbing, thus also the second machining engagement is a hob cutting process, which is also a particularly preferred variant of the machining for the inventive method. However, the invention is not limited to this type of machining. Rather, other types of machining are possible, among which in particular the continuous rolling grinding with a grinding worm is preferred, but also honing with an internal honing gear, for example. In addition, skiving, hardening peeling or scraping can be used as the machining method. Likewise, the primary machining operation may already be a chamfering and/or deburring process.

In terms of the device, the invention provides a gear cutting machine having a first workpiece spindle for rotatably holding a first workpiece at a first location in the machine, a second workpiece spindle for rotationally holding a second workpiece in a second position in the machine, and a tool-side spindle drive motor for rotationally driving at least one machining tool, in particular a hob, which is essentially characterized by a tool-side machine axis, which allows movement of the machining tool relative to the first workpiece spindle, and a directional component in the direction of the axis of the first workpiece spindle and in particular substantially (i.e. with the exception of manufacturing tolerances) parallel to it, wherein the setting of the machine axis allows a rolling machining engagement generated by using the tool-side spindle drive motor in a first feed to the first position and a second feed to the second position.

The advantages of the gear cutting machine according to the invention result from the above-explained advantages of the method according to the invention.

Thus, the gear cutting machine has a control, which controls the machine in order to perform the method according to any of preceding aspects.

The first and second workpiece-side spindle axis have a predominantly horizontal directional component, are preferably extending horizontally and in particular extend coaxially to one another.

In addition, it is preferable that the first and/or second workpiece-side spindle axes run parallel to the workpiece-side machine axis.

Furthermore, it is preferably provided that the gear-cutting machine is provided with a secondary machining unit, in particular with a chamfering and/or deburring unit, which is movable in particular parallel to the machine axis to perform a secondary machining on the first workpiece in a first displaced position and in a second displaced position a secondary machining on the second workpiece. The secondary machining unit is preferably arranged on the side of the workpieces which is substantially diametrically opposite to the side of the arrangement of the machining tool.

Further features, details and advantages of the invention will become apparent from the following description with reference to the accompanying figures, in which

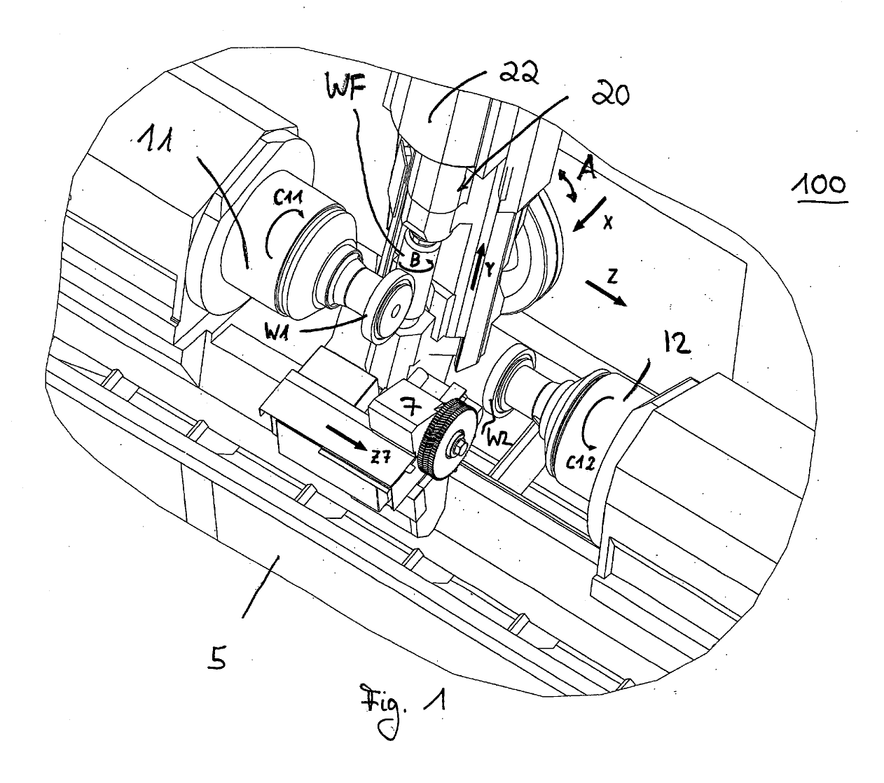

FIG. 1 shows a detail of a perspective view of a hobbing machine,

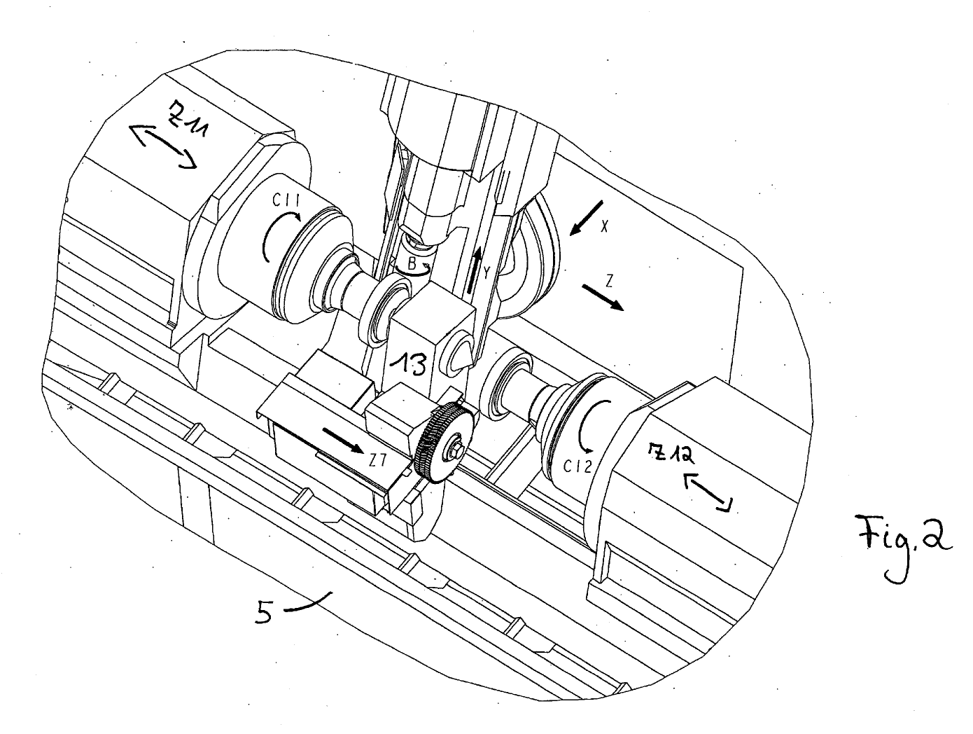

FIG. 2 shows a detail of a perspective view of a second embodiment of a hobbing machine, and

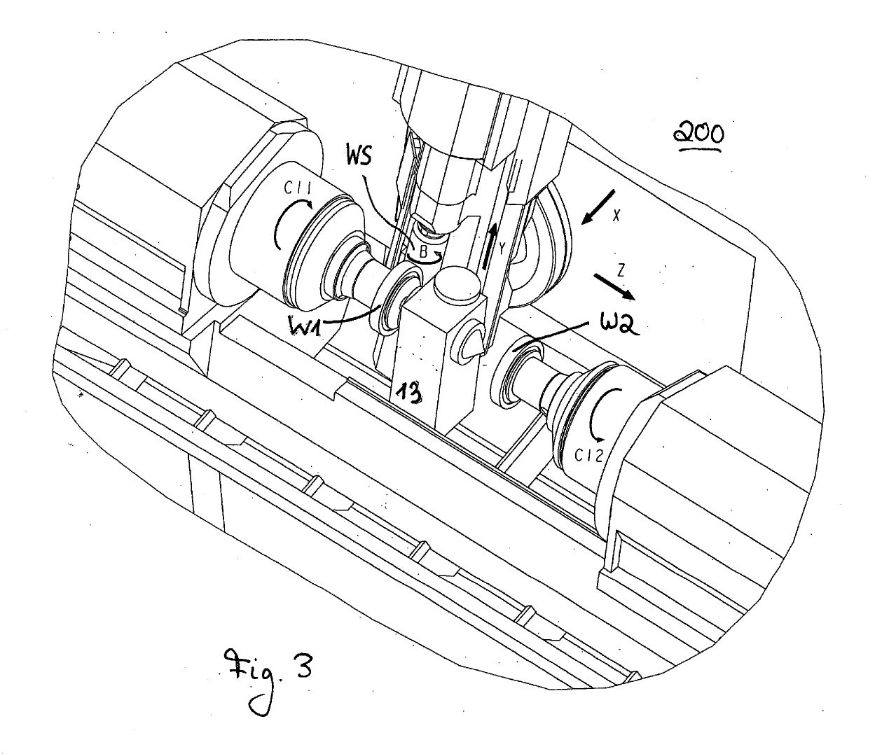

FIG. 3 shows a detail of a perspective view of a rolling grinding machine.

FIG. 1 shows in detail a hobbing machine 100, on the machine bed 5 of which two workpiece spindles 11, 12 are arranged in a fixed position in space. Shown in FIG. 1 is the axis of rotation C11 of the first workpiece spindle 11, whose spindle axis extends horizontally. The spindle axis of the second workpiece spindle 12, whose axis of rotation is denoted by C12, also extends horizontally and coaxially with the first workpiece spindle axis. Hereinafter, these axes are referred to as C11 and C12 also in terms of their horizontal position. The distance between the respective mutually facing workpiece-holders is dimensioned to allow a collision-free workpiece change on a spindle while machining takes place on the other workpiece spindle, and that, regardless of the type of clamping parts used, still a space between two workpieces remains, which are clamped on both spindles, as shown in FIG. 1. The workpiece spindles 11, 12 each have their own drive, which is a CNC-controlled direct drive.

In the situation illustrated in FIG. 1, a disk-like workpiece W1 clamped on the first workpiece spindle 1 is machined by hobbing by a hob WF, shown only schematically, for producing a gear on the workpiece W1. The bearing of the hob head 20 with hob WF and its drive 22 is such that the following machine axis movements of the hob WF are possible:

the rotation of the hob WF about its axis of rotation B,

a tangential motion Y along the axial direction of the tool axis of rotation B.

The position of this axis is not fixed in space, since the hob head 20 may be pivoted by

a pivoting movement about a pivot axis A for pivoting the hob head

a movement along the axial axis Z, which allows a displacement of the hob head 20 along the direction of the spindle axis C11 and is used in the hobbing as a feed axis, and

a movement along a radial axis X orthogonal to the axis Z, which is orthogonal to the axis Z and the tool axis of rotation B in this embodiment.

Although this is no longer apparent from FIG. 1, the machine axes X, Z are provided by a sled assembly having an axial sled movable in the Z-direction and mounted on the machine bed 5, movable in the Z direction axial slide and mounted on the axial slide, and a radial sled movable in the X direction, on which, in turn the hob head 20 is pivotally mounted about the axis A.

By moving the hob head 20 from the position shown in FIG. 1 toward the workpiece spindle 12, the hob WF can also be brought into machining engagement with a workpiece W2 clamped on the second workpiece spindle 12.

Also shown in FIG. 1 is a chamfering and deburring unit 7 which can be moved along an axial axis Z7 running parallel to the axis Z and can chamfer the workpiece W1 clamped on the first workpiece spindle 11 in a first displacement position, and which can perform, in the second displacement position shown in FIG. 1 a chamfering machining on the workpiece W2 which is clamped on the second workpiece spindle 12. In the chamfering unit used in this embodiment, the chamfer is produced at the tooth edges of the workpieces by plastic deformation. The secondary burrs which are thereby thrown on the tooth flank can be eliminated by providing a second machine cut on the workpiece by the hob WF.

A preferred machining performed on the illustrated hobbing machine 100 may be as follows:

A workpiece changer, not shown, transfers a first workpiece W1 on the first workpiece spindle 11, where it undergoes a hobbing machining by the hob WF at a first machining point defined by the axial positioning in the Z direction. This corresponds to the representation of hob WF and workpiece W1 in FIG. 1.

After generating the gear on the workpiece W1 in the first machining step, the hob WF is moved to the second machining position to generate there a gear on the workpiece W2, which is clamped on the second workpiece spindle 12. Parallel to the hobbing machining of the second workpiece, by displacing the chamfering device 7 to its first position, a chamfering of the gear of workpiece W1 may be performed.

Subsequently, the hob WF returns to the first machining position, in order to remove the secondary burrs from the tooth flanks of the workpiece W1 in a second machining step, while the chamfering unit 7 is controlled to the second position to chamfer the gear edges of the workpiece W2.

Subsequently, on the first workpiece spindle 11, the workpiece W1 may be replaced by a subsequent workpiece (blank) W3 while the hob WF returns to the second machining position in order to perform the second cut on the workpiece W2.

Thus, the hob WF and the chamfering unit 7 are axially displaced between their respective machining, in a push-pull way.

The embodiment shown in FIG. 2 is similar in many respects to the first embodiment shown in FIG. 1. Thus, the tool-side structure is the same, and reference is made in this regard to the above description. However, the workpiece spindles 11, 12 are not spatially fixed, but have a respective axial movement axis Z11 and Z12. In addition, between the two workpiece spindles 11, 12 a tailstock assembly 13 is arranged which is spatially fixed, which acts on both sides, so as to form a tailstock for both the first workpiece spindle 11 and for the second workpiece spindle 12. The second embodiment is thus also suitable for the hobbing of shafts but is also suitable as the first embodiment for disc-like workpieces. With regard to the process design with the first cut, chamfering and second cut, the same procedure can be followed as according to the above description of the first embodiment.

FIG. 3 shows a detail of a hobbing machine 200. Here, the machining head 40 carries a grinding worm WS. With regard to the machine axes, the same machine axes are provided as previously described with reference to FIG. 1. The workpiece spindles 11 and 12 are similar in this embodiment as described in the second embodiment described by means of FIG. 2, and also the double-sided tailstock assembly 13 is provided. The grinding worm WS machines the first hardened workpiece W1 already provided with a gear to eliminate hardness distortions and remove the intended thickness to the desired nominal geometry of the gear. During the machining of the grinding worm WS on the workpiece W1 clamped on the first workpiece spindle 11, a workpiece replacement of an already ground workpiece with a workpiece still to be ground can take place on the second workpiece spindle 12 and vice versa.

Not shown in FIG. 3 is a device for centering/Indexing of the gear, which is preferably provided in the form of a centering sensor, which is known to those skilled in the art. In one variant, one sensor may be provided for each workpiece spindle and may be movably arranged by a suitable positioning device for sensor detection of the rotational position of the geared workpieces.

In an alternative embodiment only one sensor may be provided, which, like the chamfering device 7 of the examples with the embodiments of hobbing machines, is movably mounted and alternately drives the workpiece clamped on the first workpiece spindle 11 and the second workpiece spindle 12 for the purpose of centering the same.

The invention is not limited to the details described in the above examples. Rather, the particular features of the above description as well as the following claims may be considered to be essential, both individually and in combination, to the practice of the invention in its various embodiments.

1. A method for creating or machining gears on workpieces, in which a rolling first machining engagement between a machining tool (WF; WS) that is driven about its rotation axis (B) by means of a tool-side spindle drive motor (22), and a first workpiece (W1) that is rotatable about the rotation axis (C1) of a first workpiece-side spindle (11) is realized at a first location on a gear-cutting machine (100; 200) and in which a second machining engagement is realized at a second workpiece (W2), different from the first workpiece, that is rotatable about the rotation axis of a second workpiece-side spindle (12) that is different from the first workpiece-side spindle, wherein the machining tool can execute, relative to the first workpiece-side spindle, a movement, serving as an axial infeed movement in the first machining engagement, along a tool-side machine axis (Z) that has a direction component in the direction of the first workpiece-side spindle axis and extends parallel thereto,
characterized in that, after the first machining engagement, a tool-side positioning movement that takes place along this tool-side machine axis (Z) and allows the second machining engagement is carried out, wherein the second machining engagement is a machining engagement that is identical to the first machining engagement in terms of type of machining, is effected using the same tool-side spindle drive motor as in the first machining, and is carried out in the gear-cutting machine at a second point that is different from the first point.

2. The method of claim 1, wherein the second machining engagement is performed with a machining tool, which rotates around the same rotation axis (B) as in the first machining engagement.

3. The method of claim 2, wherein the second machining engagement is performed with the same machining tool (WF; WS) as in the first machining engagement.

4. The method of claim 1 wherein during the first and/or second machining engagement, a workpiece-side feed motion along the workpiece-side machine axis occurs.

5. The method of claim 1 wherein the workpiece-side spindle axes (C1, C2) extend in a horizontal direction.

6. The method of claim 1 wherein the second workpiece spindle axis is parallel to the first tool-side machine axis.

7. The method of claim 1 wherein the first and/or second workpiece-side spindle is fixed in space.

8. The method of claim 1 wherein the first and/or second workpiece-side spindle is movable with a motion component along its axis (Z11, Z12).

9. The method of claim 1 wherein between both workpiece-spindles, a tailstock arrangement (13) is provided, which is spatially fixed and acting from both sides.

10. The method of claim 1 wherein on the first workpiece a successive secondary machining is performed in the same chuck as in the first machining engagement.

11. The method of claim 10, wherein the secondary machining unit (7) executing the secondary machining after the machining of the first workpiece is displaced in parallel to the tool-side machine axis for the secondary machining of the second workpiece (Z7).

12. The method of claim 10, wherein on the first workpiece a further machining engagement following the secondary machining takes place in the first location, which is of the same machining type as the first machining engagement, and which is performed by using the same tool-side spindle drive motor and the same machining tool as in the first machining engagement.

13. The method of claim 1 wherein the type of machining is a hob cutting or roll grinding.

14. A gear-cutting machine (100; 200), having
a first workpiece spindle (11) for rotatably holding a first workpiece (W1) at a first location in the machine,
a second workpiece spindle (12) for rotatably holding a second workpiece (W2) at a second location in the machine, and
a tool-side spindle drive motor (22) for rotatably driving at least one machining tool (WF;WS),
characterized by a tool-side machine axis (Z), which allows a movement of the machining tool relative to the first workpiece spindle, as well as a directional component in the direction of the axis of the first workpiece spindle, and parallel thereto, wherein the setting of this machine axis allows a rolling machining engagement, due to the use of the tool-side spindle drive motor, in a first actuation at the first location and a second actuation at the second location.

15. A gear-cutting machine having a control, which controls the machine for performing a method according to claim 1.

16. The gear-cutting machine of claim 14, wherein the first and second workpiece-side spindle axes are horizontal.

17. The gear-cutting machine of claim 14 wherein the first and/or second workpiece-side spindle axes are parallel to the tool-side machine axis.

18. The gear-cutting machine of claim 14 having a secondary machining unit (7) which may be moved in parallel to the machine axis, in order to perform, in a first displacement location, a secondary machining on the first workpiece and in a second displacement location, a secondary machining on the second workpiece.

19. The method of claim 5 wherein said spindle axes are coaxial.

20. The method of claim 10 wherein said secondary machining comprises a chamfering and/or deburring operation.

21. The gear-cutting machine of claim 14 wherein said at least one machining tool comprises a hob.

22. The gear-cutting machine of clam 16 wherein said spindle axes are coaxial.

23. The gear-cutting machine of claim 18 wherein said secondary machining unit comprises a chamfering and/or deburring unit.
